(19) United States
(12) Patent Application Publication
(10) Pub. No.: US 2021/0146437 A1
(43) Pub. Date: May 20, 2021

(54) METHOD FOR PRODUCING PARTS HAVING A COMPLEX SHAPE BY METAL POWDER INJECTION MOULDING

(71) Applicant: SAFRAN HELICOPTER ENGINES, Bordes (FR)

(72) Inventors: Yann DANIS, Moissy-Cramayel (FR); Laurent CHARES, Moissy-Cramayel (FR)

(73) Assignee: SAFRAN HELICOPTER ENGINES, Bordes (FR)

(21) Appl. No.: 16/629,379

(22) PCT Filed: Jul. 12, 2018
(86) PCT No.: PCT/FR2018/051760

§ 371 Date: Jan. 8, 2020

(30) Foreign Application Priority Data
Jul. 21, 2017 (FR) 1756916

(51) Int. Cl. B22F 3/22; B22F 3/10; B22F 1/00; B22F 3/15; B22F 5/04; B22F 3/24

(52) U.S. Cl. CPC B22F 3/225; B22F 3/1021; B22F 1/0074; B22F 2005/103; B22F 5/04; B22F 3/24; B22F 2998/10; B22F 3/15

(57) ABSTRACT

A method for producing, by a metal powder injection moulding (MIM) technique, a part formed of at least one metal and/or at least one metal alloy including at least one internal cavity. A green core of a mixture of at least one powder of at least one ceramic and of a thermoplastic binder is used.

### TECHNICAL FIELD

The present invention relates to a method for producing a part having a complex shape, more precisely a part comprising at least one inner cavity, by a metal powder injection moulding technique.

The technical field of the invention can be defined as that of the metal part production by the metal powder injection moulding technique, also referred to as the acronym “MIM” (“Metal Injection Moulding”).

### STATE OF PRIOR ART

The metal powder injection moulding technique, also referred to as the acronym “MIM” (“Metal Injection Moulding”) is a technique derived from the conventional powder metallurgy technique, which allows production of metal parts, especially of metal parts having complex shapes.

In this technique, first a mixture of a metal or metal alloy powder and a thermoplastic binder such as a wax or a polymer is prepared. It is ensured that in this mixture, the metal or alloy particles, grains are coated with the thermoplastic binder.

This mixture can then undergo a granulation operation to be shaped as solid granulates or “pellets”.

The mixture is then heated at a sufficient temperature to become liquid, for example pasty.

The liquid mixture is maintained at this temperature and is injected into a mould the shape of which corresponds to that of the part to be produced.

After cooling and solidifying the binder, a green body, compact, or “green part” is obtained, which is extracted from the mould.

Then, the binder is removed from this green body or “green part”.

In other words, the green body or “green part” is debinded during an operation referred to as debinding operation.

Debinding can be performed chemically by removing the binder using water or an organic solvent.

However, most of the time, debinding is performed thermally by heating the green part, generally in a controlled-atmosphere furnace.

At the end of debinding, a part called a “brown part” is obtained.

After debinding, the “brown” part is sintered.

During sintering, the part is heated, up to a temperature close to the melting point of the metal or metal alloy but lower than this melting point.

Sintering causes a homothetic reduction, shrinkage of the part since the metal or alloy powder grains bind to each other through diffusion thus causing the part to be densified.

The part obtained at the end of sintering may directly be used or it may undergo various treatments depending on the desired final application. Thus, the sintered part may for example be submitted to a Hot Isostatic Pressing (HIP) treatment which enables the part to be even more densified.

The metal powder injection moulding, “MIM”, technique has numerous advantages, especially it enables parts, having complex shapes with an excellent surface condition and with fine dimensional tolerances, to be made.

The metal powder injection moulding technique is particularly advantageous for producing large quantities of small size parts having complex shapes.

However, with this metal powder injection moulding technique it is difficult to produce parts having inner cavities, more precisely parts having inner cavities with undercuts, or parts having complex non-self-supporting shapes.

Such parts are especially parts used in the aeronautical industry such as turbine blades.

Indeed, with the “MIM” technique, after the binder is fully removed, before sintering, and at the beginning of sintering, when the part, as indicated above, is brought to a very high temperature, the metal or alloy powder grains are not yet sufficiently bound to be able to withstand significant overhangs, which may drive the part to collapse.

This is the reason why parts having inner cavities are not generally made with the “MIM” technique but with a conventional foundry technique, essentially the so-called lost wax foundry technique.

With this so-called lost wax foundry technique, in order to produce metal parts having inner cavities, first hard ceramic cores are made by moulding. These cores are then inserted into a mould before casting the wax, and then the metal is cast into the mould. Finally, the cores are dissolved through chemical etching to obtain the final metal part having an inner cavity. It is thus possible to make parts with closed cavities such as the cooling circuits of turbine blades.

The use of hard ceramic cores, with the “MIM” technique to produce parts having an inner cavity, would not enable a reduction in size, a shrinkage, of the “brown” part during sintering, and would therefore bring about deformation of the finished part.

More generally, it is not possible, in order to produce parts with inner cavities with the “MIM” technique, especially parts with an inner cavity having an undercut, to fill these cavities with non-deformable cores, upon injecting a metal powder. Indeed, a shrinkage of the part occurs upon sintering, and the cores cannot deform to follow this shrinkage of the part. In other words, during debinding and sintering, the green part undergoes a homothetic size reduction, whereas the cores which fill the cavities of this part—and which could be not demouldable, because of the undercuts—cannot undergo homothetic size variations, which creates a deformation or even a failure of the part.

However to make parts with inner cavities, having complex non-self-supporting shapes with the “MIM” technique, it has been suggested, to make a core, support, or supporting part the shape of which is that of the cavity, and which is obtained by injecting a feedstock consisting of a material identical to that of the green part (or a material with the same grade as the green part) and a polymer. This support or core also referred to as a “supporting part” may be covered with a anti-adhesive material which avoids, during sintering, diffusion of elements from the core towards the metal or alloy making up the part.

But to make cavities as an undercut, the core or support should be easily removable. However the use of cores consisting of the same material as that of the green part, and therefore consisting, at the end of sintering, of the same material as that of the finished part, does not enable these cores to be withdrawn, removed, when they have undercuts, without damaging the finished part. In other words, these cores consisting of the same material as that of the part are not mould releasable.

Furthermore, document FR-A1-2 944 720 describes a method for making by metal injection moulding (“MIM”), a part including at least one inner cavity, comprising the following steps of:

a) making a core replicating the shape of said cavity,

b) placing said core into an injection mould replicating the external shape of the part to be made,

c) making a mixture of metal powders and of a thermoplastic binder,

d) injecting said mixture into the injection mould, followed by a cooling step for solidification,

e) debinding the obtained part,

f) sintering the part obtained to ensure its cohesion and to densify it.

This method is characterised in that the core is made of a material which is removed during the debinding operation.

In the method of this document, the core is removed during the debinding operation, it is therefore no longer present during sintering to support the part and avoid its collapse.

Furthermore, the method of this document does not enable parts, with cavities that meet precise tolerances, to be made.

In the light of the above, there is therefore a need for a method which enables the production of a part comprising at least one inner cavity by the metal powders injection moulding, “MIM”, technique without the final, finished part being deformed.

There is also a need for such a method which does not have the drawbacks, defects, limitations and disadvantages of the above disclosed methods for producing a part comprising at least one inner cavity by the metal powders injection moulding, “MIM”, technique, such as the method of document FR-A1-2 944 720.

The purpose of the present invention is, among other things, to meet these needs.

### DESCRIPTION OF THE INVENTION

This purpose, and others are achieved, in accordance with the invention, by a method for producing, by a metal powder injection moulding (“MIM”) technique, a part to be produced consisting of at least one metal and/or at least one metal alloy including at least one inner cavity, comprising the following steps of:

a) preparing a green core the shape of which corresponds to the shape of said cavity, this core consisting of a mixture of at least one powder of at least one ceramic and of a thermoplastic binder;

b) optionally coating the green core with a anti-adhesive layer; and then performing step c), or step d), or step e);

c) placing said green core optionally coated with a anti-adhesive layer, into an injection mould replicating the external shape of the part to be produced; injecting a heated liquid mixture of at least one powder of at least one metal and/or at least one metal alloy constituting the part to be produced and of a thermoplastic binder, into said injection mould around the green core, and cooling said mixture to solidify it, whereby a green part, consisting of said solid mixture and comprising an inner cavity filled with the green core, is obtained;

d) coating said green core optionally coated with a anti-adhesive layer, with a heated liquid mixture of at least one powder of at least one metal and/or of at least one metal alloy constituting the part to be produced and of a thermoplastic binder; cooling said mixture to solidify it; and machining said mixture so that its external shape is the external shape of the part to be produced, whereby a green part, consisting of said solid mixture and comprising at least one inner cavity filled with the green core, is obtained;

e) placing said green core optionally coated with a anti-adhesive layer between at least two green parts consisting of said solid mixture of at least one powder of at least one metal and/or at least one metal alloy constituting the part to be produced and of a thermoplastic binder;

at the end of step c), or of step d), or of step e), successively carrying out the following steps f), g), and h):

f) simultaneously removing the thermoplastic binder from the green core and from the green part or from the green parts, whereby a core referred to as a “brown” core and a part referred to as a “brown” part or parts referred to as “brown” parts are obtained;

g) simultaneously sintering the brown core and the brown part to densify them, or simultaneously sintering the brown core and said at least two brown parts to densify them and so that said at least two brown parts are assembled through diffusion welding around the brown core;

h) removing the core, whereby the part to be produced is obtained.

The method according to the invention comprises a specific sequence of specific steps which has never been described or suggested in the prior art, especially as set out above. In the method according to the invention, the core consists of a mixture of a powder of at least one ceramic and a thermoplastic binder.

The core can therefore be defined as a “green” core.

The use of such a “green” core is not suggested in the prior art where the cores consist of a densified ceramic or of another material which is also densified.

Furthermore, according to the invention, the core may preferably be a soluble core.

By soluble core, it is meant that the ceramic of the core can be fully dissolved by chemical dissolution during step h) of the claimed method.

During step h), the core can also be removed by shake-out.

A ceramic core can be destroyed by shake-out whereas a metal core cannot.

Generally speaking, according to the invention, the material of the core is different from the metal and/or alloy constituting the part to be produced.

Furthermore, when the material which, in addition to the thermoplastic binder, constitutes the green core, is a soluble material, it further differs from the material which constitutes the part, in that the material which constitutes the part is not soluble during step h) of the method according to the invention.

Generally, during sintering the shrinkage of the material of the core has to be close to that of the material which constitutes the part so as not to cause a deformation.

Generally, the sintering temperatures and the expansion coefficients of the materials which constitute the core and the part, respectively, have to be equal or close to each other.

Generally, it is ensured that the characteristics of the mixture, for example of the ceramic mixture of the green core, such as the concentration and grain size, are adapted, in order to obtain shrinkages substantially equal to the shrinkage of the green part.

According to another essential characteristic of the claimed method, during step f), the thermoplastic binder is simultaneously removed from the “green” core and from the green part or from the green parts.

In other words, debinding the “green” core is performed at the same time as debinding the green part or the green parts.

According still to another essential characteristic of the claimed method, during step g) the brown core and the brown part are simultaneously sintered to densify them, or the brown core and said at least two brown parts are simultaneously sintered to densify them and for the at least two brown parts to be assembled together through diffusion welding around the brown core.

In other words, sintering the “brown” core is performed at the same time as sintering the brown part or the brown parts.

According to the invention, the core is not removed before sintering, it remains in place, inside the brown part or between the two brown parts during sintering.

The fact that the core remains in place during sintering is highly important, since as a result the core has a shrinkage similar to that of the part or parts during sintering, which especially makes it possible to support the inner portions of the parts, to avoid any deformation of the latter, and to ensure dimensional stability of these parts, in particular in the case of parts including inner cavities with undercuts or parts having non-self-supporting complex shapes.

The brown core implemented in the method according to the invention deforms during sintering as do(es) the brown part or the brown parts, it therefore perfectly adapts to the shape of this part or these parts.

At the time of sintering, the powder of the core, even when it is not sintered, makes it possible to support the inner cavity.

For example, according to the invention, the presence of the core, not only during debinding but also during sintering makes it possible to support significant overhangs and to avoid collapse of the part.

The method according to the invention differs from the method of document FR-A1-2 944 720, especially in that in the method of this document, the core is withdrawn after debinding. It therefore does not remain in place during sintering to avoid collapse of the part.

On the contrary, in the method according to the invention, the core remains in place during sintering which avoids collapse of the part.

In the method according to the invention, it is only after sintering, during step h), that the core, such as a soluble core, is removed, generally by chemical, dissolution, etching, or by shake-out.

In the method of document FR-A1-2 944 720, the core is removed after debinding and before sintering, which does not make it possible to support the part during sintering.

According to the invention, during step h), removing the core, such as a soluble core, is generally achieved by chemical, dissolution, etching, or by shake-out.

Removing the core by chemical, dissolution, etching is easy to perform, and brings about no deformation of the prepared part to be produced.

Finally, the use according to the invention of a ceramic core, for example a ceramic soluble core, makes it possible for the first time to make parts with cavities that are not demouldable (not “mould releasable”) such as air streams for an axial straightener that until now could not be made with the “MIM” technique. Indeed, such complex parts could not until now be made with the conventional “MIM” technique because the part collapsed before sintering.

According to the invention, the green core consists of a mixture of at least one powder of at least one ceramic, and a thermoplastic binder.

Said ceramic may be selected from oxide ceramics such as alumina or zirconia.

Advantageously, the metal or metal alloy which constitutes the part to be produced is selected from nickel and nickel-based alloys, titanium and titanium-based alloys, and steels, especially stainless steels.

Advantageously, the green core may be prepared by injecting the heated liquid mixture of at least one powder of at least one ceramic, and of a thermoplastic binder into a mould the shape of which corresponds to the shape of said cavity, and then cooling said mixture to solidify it.

Preferably, the green core is prepared by a ceramic powder injection moulding or “CIM” (“Ceramic Injection Moulding”) technique.

Or the green core may be prepared by machining or 3D printing shaping, for example by the Fused Deposition Modeling or “FDM” technique, using the mixture of at least one powder of at least one ceramic, and of a thermoplastic binder.

The core can optionally be removed by shake-out.

Advantageously, the part obtained at the end of step h) may furthermore undergo one or several thermal and/or mechanical treatment(s) such as a hot isostatic pressing (HIP) treatment.

If a chemical dissolution of the core is performed, then the ceramic of the core will be selected so that the core is dissolved by the chemical composition used for dissolution, such as soda whereas the part to be prepared, to be produced is not dissolved by this chemical composition.

The chemical composition used for dissolving the core may be for example a base or an acid.

Advantageously, the part to be produced is selected from parts of aeronautical turbomachineries, such as axial straighteners, radial straighteners, distributors, and centrifugal diffusers.

The invention will be better understood upon reading the following detailed description given by way of non-limiting illustration. This description is made in connection with the appended drawings.

### BRIEF DESCRIPTION OF THE DRAWINGS

FIGS. 1 to 4 are schematic vertical cross-section views which illustrate the different steps of the method according to the invention.

FIG. 1 illustrates preparation of a green core.

FIG. 2 illustrates overmoulding of the green core.

FIG. 3 illustrates the debinding and sintering steps.

FIG. 4 illustrates the final step of dissolving the core.

### DETAILED DISCLOSURE OF PARTICULAR EMBODIMENTS

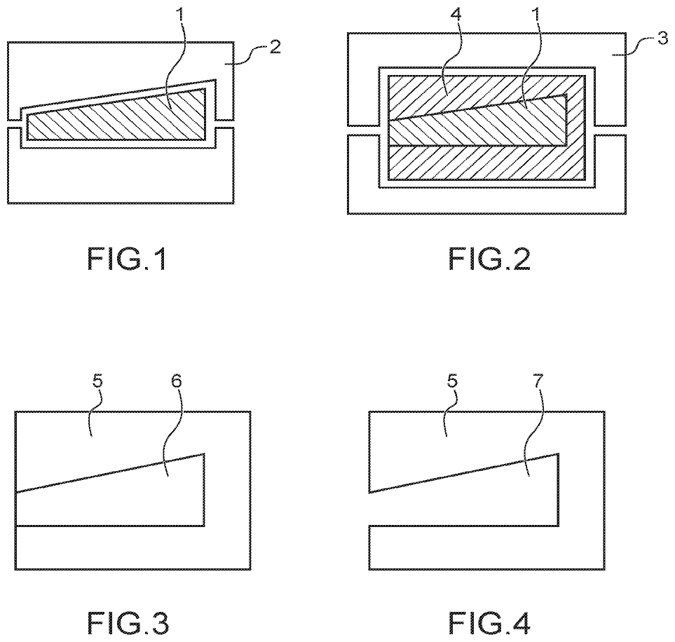

FIG. 1 shows the preparation of a core A, 1, (step a) of the method according to the invention), the shape of which corresponds to the shape of the cavity of the part to be produced, this core consisting of a mixture of at least one powder of at least one ceramic, and a thermoplastic binder. This core A, 1, may therefore be referred to as a “green core”.

The nature of the core powder, especially its composition and grain size, as well as the powder and binder distribution into the core, are to be adapted depending on the proprieties of the part to be produced, in particular depending on the sintering temperature of the metal or metal alloy that constitutes the part to be produced and on the expansion coefficient of the metal or a metal alloy which constitutes the part to be produced.

Thus, in the case where the core powder is alumina powder, its grain size may be such that it has a D₉₀<30 μm. The core may comprise from 60% to 80% volume of powder and from 20% to 40% volume of binder.

FIG. 1 shows a first embodiment for preparing the green core A,1, wherein the core is prepared by injecting the heated liquid mixture of at least one powder of at least one ceramic, and a thermoplastic binder into a mould 2 the shape of which corresponds to the shape of the cavity of the part to be produced.

The heated liquid mixture is then cooled to be solidified.

According to a second embodiment (not represented) for preparing the green core A, the latter may be prepared by machining the mixture of at least one powder of at least one ceramic, and a binder.

According to a third embodiment (not represented) for preparing the green core A, the latter can be prepared by 3D printing the mixture of at least one powder of at least one ceramic, and a binder.

In other words and to sum up, the green core A may be made by moulding or by machining or by 3D printing in the green part condition.

Then, the thus prepared green core is optionally coated with a anti-adhesive layer (step b) of the method according to the invention).

This anti-adhesive layer may be made of any known anti-adhesive material used in this technical field.

Thus, this anti-adhesive material may be for example chromium oxide.

The green core coated with the anti-adhesive layer is then overmoulded by a mixture of at least one powder of at least one metal and/or at least one metal alloy constituting the part to be produced B and a thermoplastic binder. This mixture is generally called a “feedstock”.

FIG. 2 shows a first embodiment of this overmoulding step (step c) of the method according to the invention), wherein said green core A,1, coated with a anti-adhesive layer (not represented) is placed into an injection mould 3 replicating the external shape of the part to be produced; a heated liquid mixture of at least one powder of at least one metal and/or at least one metal alloy constituting the part to be produced and of a thermoplastic binder is injected into said injection mould 3 around the green core 1; and said mixture is cooled to be solidified, whereby a green part B,4, consisting of said solid mixture and comprising an inner cavity filled with the core A,1, is obtained.

In addition to the first embodiment of the overmoulding step shown in FIG. 2, this overmoulding step may be performed, according to a second embodiment (not represented) of this overmoulding step (step d) of the method according to the invention), by coating said core 1 coated with a anti-adhesive layer, with a heated liquid mixture of at least one powder of at least one metal and/or at least one metal alloy constituting the part to be produced and of a thermoplastic binder; by cooling said mixture to solidify it; and by machining said mixture so that its external shape is the external shape of the part to be produced. A green part consisting of said solid mixture and comprising at least one inner cavity filled by the core is thus obtained in the same way as in the first embodiment.

The core coated with a anti-adhesive layer may be coated with the feedstock by dipping the core coated with the anti-adhesive layer in liquid feedstock.

Machining may be performed by any appropriate known machining technique.

In other words, to sum up, overmoulding may be performed in a specific mould or by dipping in liquid feedstock and then the solid cooled feedstock is machined.

Instead of overmoulding the core A,1, coated with the anti-adhesive layer by the mixture of at least one powder of at least one metal and/or at least one metal alloy constituting the part to be produced B and if a thermoplastic binder (feedstock), it is possible according to another embodiment (step e) of the above-described method according to the invention to place, insert, integrate, said green core coated with a anti-adhesive layer between several (at least two) green parts consisting of said solid mixture (feedstock) of at least one powder of at least one metal and/or at least one metal alloy constituting the part to be produced and of a thermoplastic binder.

During sintering, the at least two green parts, which meanwhile have been debinded, thereby called “brown” parts will be assembled together by diffusion welding around the core itself sintered, in other words, during sintering, these at least two parts will bond to each other to thus surround the core also sintered and form the part to be produced.

The green parts may be obtained by any appropriate technique.

Thereby, these green parts may be obtained by powder injection moulding, by an additive manufacturing technique such as the Fused Deposition

Modeling or “FDM” technique or by green machining.

In other words, to sum up, the green part to be produced B may not be overmoulded on the core, and the green core may be inserted between at least 2 moulded or machined green parts.

FIG. 3 illustrates the debinding f) and sintering g) steps of the claimed method.

These steps are successively performed at the end of step c), step d) or step e).

During step f), which is therefore called a debinding step, are simultaneously removed the thermoplastic binder from the core (green core) and the thermoplastic binder from the green part or from the green parts.

Debinding may be performed by any known debinding technique.

This debinding technique is suitably selected according to the nature of the thermoplastic binder used, such as a resin or a polymer.

This debinding technique may be a catalytic, thermal, solvent, water, or supercritical fluid such as supercritical CO₂ debinding technique.

At the end of this debinding step, a debinded green part called a “brown” part 5, consisting of said debinded solid mixture and comprising at least one inner cavity filled with the debinded green core 6 which may be called a “brown” core is therefore obtained.

Or, at the end of this debinding step, a “brown” core between several (at least two) debinded green parts, referred to as “brown” parts, is obtained.

After the debinding step, which is step f) of the claimed method, the “brown” core 6 and the “brown” part 5 are simultaneously sintered (step g) of the method according to the invention) to densify them, or the “brown” core and said at least two “brown” parts are simultaneously sintered to densify them and so that the at least two brown parts are assembled together by diffusion welding around the core thus forming the part to be produced.

Sintering is generally performed in a furnace where the “brown” core 6 and the “brown” part 5, or the “brown” core and said at least two “brown” parts are heated up to a temperature close to the melting point of the metal or of the alloy constituting part B.

The sintering temperature, duration and the atmosphere in the furnace are controlled so that the metal or alloy particles of part B bind together by diffusion. The pores of the “brown” core and the pores of the “brown” part(s) are gradually reduced and the brown part(s) densify during this sintering step. Densification generally leads to a shrinkage of the brown part or of the brown parts which is for example in the order of 10% to 20%. According to the invention, shrinkage of the brown part or of the brown parts on the one hand, and shrinkage of the brown core on the other hand are generally equal or close to each other, that is the shrinkage of the brown core and of the brown part(s) do not differ too much, for example not more than 10%, 5%, or even 1%, so that no deformation of the part occurs during sintering.

However, the value of the difference between shrinkage of the brown part or of the brown parts on the one hand, and shrinkage of the brown core on the other hand cannot generally be fixed since this value also depends on expansion coefficients. Furthermore, hightening stresses between the part and the core have also to be managed.

As a result, it is possible to have slightly different shrinkages enabling stresses due to differential expansion during cooling not to be created.

As is represented in FIG. 4, during step h) of the method according to the invention removing the soluble core 6 is performed by chemical, dissolution, etching to thus obtain a part 5 including an inner cavity instead of the core 6.

This chemical, dissolution, etching is generally performed using a base such as soda, for example in the case where the core is made of alumina.

Depending on the solidity condition of the core, other solutions for eliminating the latter can be contemplated such as shake-out.

Advantageously, the part 5 obtained at the end of step h) may undergo one or several heat and/or mechanical treatment(s) such as a hot isostatic pressing (HIP) treatment to further increase the density of the part.

1. A method for producing, by a metal powder injection moulding technique, a part of at least one metal and/or at least one metal alloy including at least one inner cavity, comprising the following steps of:
a) preparing a green core the shape of which corresponds to the shape of said cavity, said core comprising a mixture of at least one powder of at least one ceramic and of a thermoplastic binder;
b) optionally coating the green core with a anti-adhesive layer; and then performing step c), or step d), or step e);
c) placing said green core optionally coated with a anti-adhesive layer, into an injection mould replicating the external shape of the part to be produced; injecting a heated liquid mixture of at least one powder of at least one metal and/or at least one metal alloy constituting the part to be produced and of a thermoplastic binder, into said injection mould around the green core, and cooling said mixture to solidify it, whereby a green part of said solid mixture and comprising an inner cavity filled with the green core is obtained;
d) coating said green core optionally coated with a anti-adhesive layer, with a heated liquid mixture of at least one powder of at least one metal and/or of at least one metal alloy constituting the part to be produced and of a thermoplastic binder; cooling said mixture to solidify it; and machining said mixture so that its external shape is the external shape of the part to be produced, whereby a green part consisting of said solid mixture and comprising at least one inner cavity filled with the green core is obtained;
e) placing said green core optionally coated with a anti-adhesive layer between at least two green parts consisting of said solid mixture of at least one powder of at least one metal and/or at least one metal alloy constituting the part to be produced and of a thermoplastic binder;
at the end of step c), or step d), or step e), successively carrying out following steps f), g), and h):
f) simultaneously removing the thermoplastic binder from the green core and from the green part or from the green parts, whereby a core called a “brown” core and a part called a “brown” part or parts called “brown” parts are obtained;
g) simultaneously sintering the brown core and the brown part to densify them, or simultaneously sintering the brown core and said at least two brown parts to densify them and so that said at least two brown parts are assembled together through diffusion welding around the brown core;
h) removing the core, whereby the part to be produced is obtained.

2. The method according to claim 1, wherein said ceramic is selected from oxide ceramics such as alumina or zirconia.

3. The method according to claim 1, wherein the green core is prepared by injecting the heated liquid mixture of at least one powder of at least one ceramic, and of a thermoplastic binder into a mould the shape of which corresponds to the shape of said cavity, and then cooling said mixture to solidify it.

4. The method according to claim 3, wherein the green core is prepared by a ceramic powder injection moulding or “CIM” technique.

5. The method according to claim 1, wherein the green core is prepared by machining the mixture of at least one powder of at least one ceramic, and of a thermoplastic binder.

6. The method according to claim 1, wherein the green core is prepared by 3D printing shaping, using the mixture of at least one powder of at least one ceramic, and of a thermoplastic binder.

7. The method according to claim 1, wherein the metal or metal alloy which constitutes the part to be produced is selected from nickel and nickel-based alloys, titanium and titanium-based alloys, and stainless steels.

8. The method according to claim 1, wherein the part obtained at the end of step h) further undergoes one or several heat and/or mechanical treatments such as a hot isostatic pressing treatment.

9. The method according to claim 1, wherein the part to be produced is selected from parts of aeronautical turbomachineries including radial straighteners, axial straighteners, distributors, and centrifugal diffusers.
